(19) United States
(12) Patent Application Publication
(10) Pub. No.: US 2008/0274347 A1
(43) Pub. Date: Nov. 6, 2008

(54) Method for Producing Film Using Aerosol, Particles Mixture Therefor, and Film and Composite Material

(76) Inventors: Junichi Iwasawa, Fukuoka-Ken (JP); Hironori Hatono, Fukuoka-Ken (JP); Hiroaki Ashizawa, Fukuoka-Ken (JP); Tomokazu Ito, Fukuoka-Ken (JP); Kaori Miyahara, Fukuoka-Ken (JP)

Correspondence Address: LADAS & PARRY LLP, 26 WEST 61ST STREET, NEW YORK, NY, 10023, US

(21) Appl. No.: 11/547,515

(22) PCT Filed: Mar. 18, 2005
(86) PCT No.: PCT/JP2005/005009

§ 371 Date: Sep. 29, 2006

(30) Foreign Application Priority Data
Mar. 31, 2004 (JP) 2004-107256
Mar. 15, 2005 (JP) 2005-073351

(51) Int. Cl. B05D 1/12; C09D 1/00; B32B 5/16

(52) U.S. Cl. 428/323; 427/180; 106/286.8

(57) ABSTRACT

There is disclosed a method for producing a film with use of aerosol which is capable of forming a film of satisfactory quality at a high film formation rate. In the method, first, a carrier gas is mixed into a particle mixture which comprises raw fine particles comprising a brittle material as a main component and having a 50% average particle diameter of 0.010 μm to 1.0 μm on a volume basis, and auxiliary particles comprising a brittle material of the same type as or a different type from the brittle material of the raw fine particles as a main component and having a 50% average particle diameter of 3.0 μm to 100 μm on a volume basis, to form an aerosol. The aerosol is ejected onto the surface of a substrate to make the particle mixture come into collision with the substrate, so that the collision crushes or deforms the raw fine particles to form a film on the substrate.

### BACKGROUND OF THE INVENTION

1. Field of the Invention

This invention relates to a method for using aerosol to produce a film of ceramics, semiconductors and the like, a particle mixture used in the method, and a film and a composite material obtained by the method.

2. Background Art

A method for forming a film by use of aerosol, which is called an aerosol deposition method, has been recently proposed as a new technique for forming a film of ceramics and the like. In this method, an aerosol containing fine particles of a brittle material such as ceramics is formed. The aerosol is then ejected onto the surface of a substrate to make the fine particles come into collision with the substrate, so that the collision crushes or deforms the fine particles to form a film on the substrate. According to the method, a dense-ceramics thick film exhibiting a high hardness and having a thickness of 1 μm to several hundred μm is able to be formed at room temperature directly on the surface of the substrate of metal, ceramics, a glass material or the like. It has been said that the formation of such a thick film is difficult with the use of a conventional film forming method, for example, sol-gel method, CVD, or PVD.

A known method for obtaining a compact film in a high density uses, as a material for fine particles used for aerosol, brittle-material fine particles in which internal strains are applied, to stimulate deformation or fracture of the fine particles when they come into collision with the substrate (see WO01/27348, for example).

Further, a known method for obtaining a dense film at low temperatures uses, as a material for fine particles used for aerosol, a combination of fine particles for crushing having an average particle diameter of 0.5 μm to 5 μm and brittle-material fine particles having an average particle diameter of 10 nm to 1 μm (see JP-A-2001-3180, for example).

Still further, a known method for obtaining a dense film exhibiting a high hardness uses, as a material for fine particles used for aerosol, alumina particles having an average particle diameter of 0.1 μm to 5 μm and having an O/Al ratio higher than the stoichiometric composition to form a film (see JP-A-2002-206179, for example).

### SUMMARY OF THE INVENTION

The present inventors have now found that a film of a good quality can be formed at an extremely high film formation rate by impacting and depositing, onto and on a substrate, aerosol formed by the use of a particle mixture of raw fine particles having a 50% average particle diameter (D50) of 0.010 μm to 1.0 μm on a volume basis, and auxiliary particles having a 50% average particle diameter (D50) of 3.0 μm to 100 μm on a volume basis.

Accordingly, it is an object of the present invention to provide a method for producing a film with use of aerosol which is capable of forming a film of satisfactory film quality at an extremely high film formation rate.

A method for producing a film by use of aerosol of the present invention comprises:

mixing a particle mixture with a carrier gas to form an aerosol;

ejecting the aerosol onto a surface of a substrate to make the particle mixture come into collision with the substrate, the collision crushing or deforming the particles to form a film on the substrate,

wherein the particle mixture comprises raw fine particles comprising a brittle material as a main component and having a 50% average particle diameter (D50) of 0.010 μm to 1.0 μm on a volume basis, and auxiliary particles comprising a brittle material of the same type as or a different type from the brittle material of the raw fine particles as a main component and having a 50% average particle diameter (D50) of 3.0 μm to 100 μm on a volume basis.

Also, particle mixture of the present invention is the particle mixture used as a material for the film in the above method, comprising:

raw fine particles comprising a brittle material as a main component and having a 50% average particle diameter (D50) of 0.010 μm to 1.0 μm on a volume basis; and

auxiliary particles comprising a brittle material of the same type as or a different type from the brittle material of the raw fine particles as a main component and having a 50% average particle diameter (D50) of 3.0 μm to 100 μm on a volume basis.

Further, according to the present invention, there is provided a film produced by the foregoing method.

Furthermore, according to the present invention, there is provided a composite material including a substrate and a film formed on the substrate and produced by the foregoing method.

### BRIEF DESCRIPTION OF THE DRAWINGS

FIG. 1 is a diagram illustrating an example of a film producing apparatus used in a method of the present invention.

FIG. 2 is a graph showing a particle size distribution of Sample 1 on a volume basis which is obtained in Example 1.

FIG. 3 is a graph showing a particle size distribution of Sample 2 on a volume basis which is obtained in Example 1.

FIG. 4 is a graph showing a particle size distribution of Comparative Sample 1 on a volume basis which is obtained in Example 2.

FIG. 5 is a graph showing a particle size distribution of Comparative Sample 2 on a volume basis which is obtained in Example 2.

### DETAILED DESCRIPTION OF THE INVENTION

### Definition

In the present invention, “a 50% average particle diameter on a volume basis (D50)” refers to a particle diameter of particles when the cumulative volume of fine particles counted from the smaller particle diameter side reaches 50% in the particle-size distribution measurement data measured by the use of a laser-diffraction-type particle-size distribution instrument.

In the present invention, “a 90% average particle diameter on a volume basis (D90)” refers to a particle diameter of particles when the cumulative volume of fine particles counted from the smaller particle diameter side reaches 90% in the particle-size distribution measurement data measured by the use of a laser-diffraction-type particle-size distribution instrument.

In the present invention, “a 10% average particle diameter on a number basis (D10)” refers to a diameter of particles when the cumulative number of fine particles counted from the smaller particle diameter side reaches 10% in the particle-size distribution measurement data measured by the use of a laser-diffraction-type particle-size distribution instrument.

In the present invention, “particles” means “primary particles” and, are distinguished powder in which primary particles are naturally agglomerated.

Method for Producing Film Using Aerosol and Particle Mixture

The method for forming a film according to the present invention can be carried out in accordance with an aerosol deposition method or a method which is called the Ultra-Fine particles beam deposition method. Therefore, the method according to the present invention has substantially the same basic principle as that of the method described in WO01/27348, for example, the disclosure of which is incorporated into a part of the disclosure of the present specification. If the disclosure of this publication and the disclosure described below differ from each other, it is needless to say that the following description is paramount and its contents are the present invention.

In the method of the present invention, first of all, there is provided a particle mixture comprising raw fine particles and auxiliary particles. The raw fine particles comprise a brittle material as a main component, and are of relatively small particle size having a 50% average particle diameter (D50) of 0.010 μm to 1.0 μm on a volume basis, which are particles mainly forming a film. On the other hand, the auxiliary particles comprise, as a main component, the same type or a different type of brittle material as or from that of the brittle material of the main component of the raw fine particles, and are of relatively large particle size having a 50% average particle diameter (D50) of 3.0 μm to 100 μm on a volume basis, which are particles mainly facilitating the formation of the film, and are not necessarily required to form the film. In the present invention, the particle mixture is mixed with a carrier gas to form aerosol. Then, the aerosol is ejected onto the surface of a substrate so as to make the fine particles come into collision with the substrate, while the fine particles are crushed or deformed by the collision to form a film on the substrate. In the present invention, by the use of a particle mixture constituted of a combination of particles of specific particle diameters to form a film, the formation of the film of a good quality, such as in the hardness, density and the like, at an extremely high film formation rate can be achieved. Specially, the method of the present invention has the advantages that a significant increase in the film formation rate and also an improvement of the quality of the film, particularly the hardness and the density, are achieved by the use of a combination of the raw fine particles and the auxiliary particles even if a particle diameter of raw fine particles does not allow the raw fine particles alone to form a film or may possibly bring about an insufficient film formation rate or an insufficient quality of the film.

In the method according to the present invention, the formation of a film by collision of a particle mixture with a substrate is considered as described below. However, the following description is just an assumption and the present invention is not at all limited to the assumption. First, because ceramics are in an atomic bond state of showing strong ionic bonding properties or strong covalent boding properties having few free electrons, the ceramics have properties of having a high hardness and low impact resistance. Semiconductors such as silicon and germanium are also a brittle material having no ductility. Accordingly, when a mechanical impact is added to the raw fine particles comprising such a brittle material as the main component, displacement or deformation can occur in a crystal lattice along a cleavage face on an interface between crystals or the like or the raw fine particles can be crushed. When the phenomena occur, a new surface is created on the displaced face or the fracture face. The new surface originally exists inside the fine particle and is a face having an exposure of an atom which has bonded to another atom. A part of the new surface corresponding to an atom layer is exposed to a surface state which is forcibly made unstable by an external force from the originally stable atomic bonding state, resulting in a state of a high surface energy. Then, the active surface joins the surface of an adjacent brittle material, a new surface of the same adjacent brittle material, or the substrate surface so as to become a stable state. At this point, it is considered that, in the boundary area with the substrate, a part of the re-bonding fine particles bite into the substrate surface to form an anchor portion, and films formed of the poly crystal brittle material are deposited on the anchor portion. It is considered that the continuous application of the mechanical impact force from the external induces sequential occurrence of the aforementioned phenomena and the bond is developed by the repeated deformation and crushing of the fine particles, leading to an increase in density of the formed structure. At this point, in the present invention, because the auxiliary particles have a relatively large particle diameter and therefore have a high kinetic energy, it is considered that the auxiliary particles increase the aforementioned mechanical impact force to significantly enhance the film formation rate, and contribute to the improvement of a quality of the film, particularly, the hardness and the density.

According to a preferred embodiment of the present invention, it is preferred that, in the film according to the present invention obtained as described above, the crystals, which are poly crystals and form a film, do not substantially have a crystal orientation, that a grain boundary layer formed of a vitreous material does not substantially exist on the interface between crystals, and that a part of the film forms an anchor portion biting into the substrate surface. Such a film can be a dense-ceramic thick film having a high hardness, superior wear resistance and substrate adhesion properties as well as a high breakdown voltage.

Both the raw fine particles and the auxiliary particles in the present invention comprise a brittle material as the main component. In the present invention, the raw fine particles and the auxiliary particles may comprise the same type of a brittle material as the main component or may comprise a different type of a brittle material from each other as the main component. As long as the brittle material used in the present invention has properties of being deposited as a film on a substrate by being crushed or deformed when the brittle material as the raw fine particle aerosol is ejected onto the surface of the substrate, the brittle material used in the present invention is not particularly limited, and various material can be used, in the case of which a nonmetallic inorganic material is desirable. In this connection, the crushing and deformation can be determined when, in a crystallite size measured and calculated by a Scherrer method using X-ray diffraction, a crystallite size of the film is smaller than a crystallite size of the raw fine particles.

According to the preferred embodiment of the present invention, the nonmetallic inorganic material is preferably at least one selected from the group consisting of an inorganic oxide, inorganic carbide, inorganic nitride, inorganic boride, a multi-component solid solution thereof, ceramics and semiconductor materials. Examples of inorganic oxide include an aluminum oxide, titanium oxide, zinc oxide, tin oxide, iron oxide, zirconium oxide, yttrium oxide, chromium oxide, hafnium oxide, beryllium oxide, magnesium oxide, silicon oxide and the like. Examples of inorganic carbide include diamond, boron carbide, silicon carbide, titanium carbide, zirconium carbide, vanadium carbide, niobium carbide, chromium carbide, tungsten carbide, molybdenum carbide, tantalum carbide, and the like. Examples of inorganic nitride include boron nitride, titanium nitride, aluminum nitride, silicon nitride, niobium nitride, tantalum nitride and the like. Examples of inorganic boride include boron, aluminum boride, silicon boride, titanium boride, zirconium boride, vanadium boride, niobium boride, tantalum boride, chromium boride, molybdenum boride, tungsten boride, and the like. Examples of ceramics include piezoelectric or pyroelectric ceramics, such as barium titanate, lead titanate, lithium titanate, strontium titanate, aluminum titanate, PZT, PLZT; high-toughness ceramics, such as sialon, cermet; biocompatible ceramics, such as mercury apatite, calcium phosphate; and the like. Examples of semiconductor materials include semiconductor materials in which various dopants such as phosphorus are added into silicon, germanium or both of them; semiconductor compounds such as gallium arsenide, indium arsenide, cadmium sulfide; and the like. Further, according to another preferred embodiment of the present invention, it is possible to use an organic material having brittleness such as rigid vinyl chloride, polycarbonate, acrylic.

The raw fine particles used in the present invention have a 50% average particle diameter (D50) of 0.010 μm to 1.0 μm, preferably 0.030 μm to 0.80 μm, more preferably 0.10 μm to 0.50 μm, on a volume basis.

The auxiliary particles used in the present invention have a 50% average particle diameter (D50) of 3.0 μm to 100 μm, preferably 5.0 μm to 50 μm, more preferably 7.0 μm to 20 μm, on a volume basis.

According to a preferred embodiment of the present invention, the particle mixture has preferably a 10% average particle diameter (D10) of 0.03 μm to 0.50 μm on a number basis, and a 90% average particle diameter (D90) of 3.00 μm to 25 μm on a volume basis. The particle mixture has preferably a 10% average particle diameter (D10) of 0.05 μm to 0.30 μm, more preferably, 0.06 μm to 0.20 μm, on a number basis. The particle mixture has preferably a 90% average particle diameter (D90) of 5.00 μm to 25 μm, more preferably, 5 μm to 18 μm, on a volume basis.

According to a preferred embodiment of the present invention, a ratio of the number of raw fine particles to that of auxiliary particles in the particle mixture is preferably 1.0×10² to 1.0×10⁷, preferably 1.0×10³ to 1.0×10⁷, more preferably 1.0×10⁴ to 1.0×10⁷, most preferably 1.0×10⁴ to 1.0×10⁶.

According to a preferred embodiment of the present invention, it is possible to use a mixture of fine particles of two or more types of brittle materials as the raw fine particles. As a result, a film of composition and structure, not easily formed by a conventional method, is able to be easily formed, which makes it possible to realize a new type film and a new type composite material which are not be realized conventionally. Further, according to another preferred embodiment of the present invention, a mixture of fine particle of two or more types of brittle materials may be used as the auxiliary particles.

Substrate

The substrate used in the method according to the present invention is not limited as long as the material has the hardness having the degree to which a sufficient mechanical impact force for crushing or deforming the fine particle material can applied to the material by ejecting an aerosol onto the substrate to lead to the collision of the particle mixture. Preferred examples of substrates include glass, metal, ceramics, semiconductors, and organic compounds, and composite materials thereof.

Manufacturing of Film and Apparatus Therefor

In the method according to the present invention, a carrier gas is mixed into the aforementioned particle mixture to form an aerosol. The aerosol in the present invention is an aerosol in which a particle mixture is dispersed in a carrier gas, which is desirably in a state of dispersing primary particles but may contain aggregated granules resulting from aggregation of the primary particles. A commercially available aerosol generator may be used to form the aerosol in accordance with a well-known method. At this point, the particle mixture of the present invention may be pre-fed into the aerosol generator, may be mixed with the carrier gas in the middle of a pipe extending from the aerosol generator to nozzle, or alternatively may be mixed with the carrier gas in a position between the nozzle and the substrate immediately before the carrier gas reaches the substrate. The carrier gas is not particularly limited as long as it is inactive with the particle mixture and also does not adversely affect the composition of the film. Preferred examples of carrier gases include nitrogen, helium, argon, oxygen, hydrogen, dry air and a mixture gas of them.

According to a preferred embodiment of the present invention, types and/or partial pressures of the carrier gas can be controlled in order to control composition in the film or control the atomic configuration. In this way, the electric characteristics, mechanical characteristics, chemical characteristics, optical characteristics, magnetic characteristics and the like of the film can be controlled.

In the method according to the present invention, the aerosol is ejected onto the surface of the substrate to make the particle mixture collide with the substrate, so that the collision crushes or deforms the raw fine particles to form a film on the substrate. The temperature conditions on this process may be determined appropriately, but this process can be performed at a remarkably lower temperature than a general sintering temperature of ceramics, for example, 0° C. to 100° C., typically at room temperature.

According to a preferred embodiment of the present invention, ejecting the aerosol onto the substrate is preferably performed by ejecting the aerosol from a nozzle, more preferably by ejecting the aerosol from a nozzle while the nozzle is moved relatively to the substrate, that is, by ejecting the aerosol while the nozzle is scanned on the substrate. A film formation rate on this process is preferably 1.0 μm·cm/min. or more, more preferably 1.2 μm·cm/min. or more, furthermore preferably 1.4 μm·cm/min. or more, most preferably 1.6 μm·cm/min. or more. Further, according to a preferred embodiment of the present invention, an ejecting rate of the aerosol is preferable within a range from 50 m/s to 450 m/s, more preferable within a range from 150 m/s to 400 m/s. As a result of setting such a range, the new surfaces are apt to be formed when the fine particles come into collision with the substrate, superior film formation properties are achieved, and the film formation rate is increased.

According to a preferred embodiment of the present invention, the thickness of the film is preferably 0.5 μm or more, more preferably 1 μm to 500 μm, furthermore preferably 3 μm to 100 μm. As described above, according to the method of the present invention, it is possible to form a thicker film as compared with other film-forming methods such as a PVD method, a CVD method, and a sol-gel method.

According to a preferred embodiment of the present invention, the film is preferably formed under a reduced pressure. In this way, the activity of the new surfaces formed in the raw fine particles can be retained for a certain period of time.

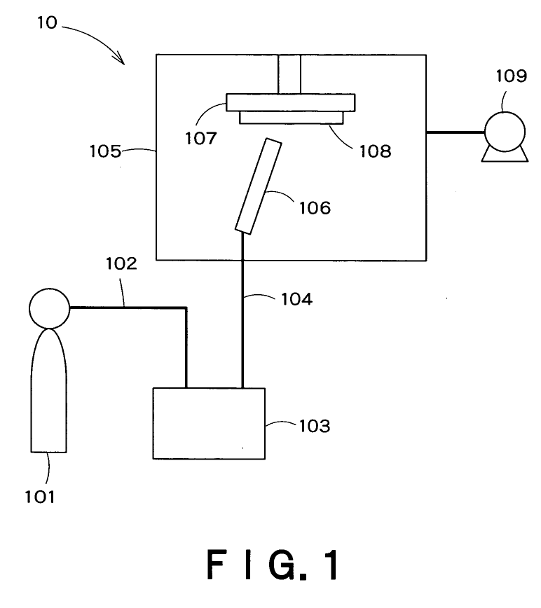

FIG. 1 shows an example of a film producing apparatus for carrying out the method of the present invention. A producing apparatus 10 shown in FIG. 1 has a nitrogen gas tank 101 connected through a gas carrier pipe 102 to an aerosol generator 103 storing aluminum oxide fine particles, and through an aerosol carrier pipe 104 to a nozzle 106 which is mounted in a forming chamber 105 and has an opening of 0.4 mm vertical and 17 mm horizontal. A metal substrate of various types 108 placed on an XY stage 107 is mounted in front to the leading end of the nozzle 106, and the forming chamber 105 is connected to a vacuum pump 109.

An example of the film producing method using the producing apparatus 10 will be described below. The nitrogen gas tank 101 is opened to introduce a high-purity nitrogen gas through the gas carrier pipe 102 to the aerosol generator 103, in order to generate an aerosol in which the aluminum oxide fine particles and the high-purity nitrogen gas are mixed. The aerosol is conveyed through the aerosol carrier pipe 104 to the nozzle 106, and then is ejected at high speed from the opening of the nozzle 106. The aerosol ejected from the nozzle 106 comes into collision with the metal substrate 108 and forms a film at the collision region. Then, the XY stage 107 is operated to move the metal substrate 108 back and forth to form a film in a predetermined area. The film forming can be performed at room temperature.

### EXAMPLES

The present invention is described in more detail in the following examples. It should be noted that the present invention is not limited to the examples.

### Example 1

### Preparation of a Particle Mixture

As raw fine particles, two types of commercially available aluminum oxide fine particles were provided. The 50% average particle diameter of the fine particles on a volume basis was measured as described below. First, small amount of the aluminum oxide fine particles were taken out and put into a test tub, and then 3 ml of ion-exchanged water and a few drops of 0.2% sodium hexametaphosphate solution were added into it, and then they were sufficiently mixed. Next, the mixture liquid was injected into a dispersion bath of a laser diffraction/scattering-type particle-diameter distribution measuring instrument (LA-920 produced by HORIBA Seisakusho) and then was irradiated for 5 minutes with the instrument's built-in supersonic wave (30 W), thereafter an optical axis was adjusted for measurement. As a result, the 50% average particle diameters of the two types of the raw fine particles on a volume basis were as follows.

Raw fine particles 1: 0.17 μm

Raw fine particles 2: 0.60 μm

As auxiliary particles, two types of commercially available aluminum oxide fine particles were provided. As in the above case, the 50% average particle diameters of these particles on a volume basis were measured. As a result, the 50% average particle diameters of the two types of the auxiliary particles on a volume basis were as follows.

Auxiliary particles 1: 5.9 μm

Auxiliary particles 2: 11.0 μm

Next, the raw fine particles 1 and 2 and the auxiliary particles 1 and 2 were mixed together at the following number ratios, and Samples 1 to 4 were obtained as four particle mixtures.

Sample 1:
(auxiliary particles 2):(raw fine particles 1)=1: 10⁶

Sample 2:
(auxiliary particles 2):(raw fine particles 2)=1: 10⁴

Sample 3:
(auxiliary particles 1):(raw fine particles 1)=1: 10⁴

Sample 4:
(auxiliary particles 1):(raw fine particles 2)=1: 10⁴

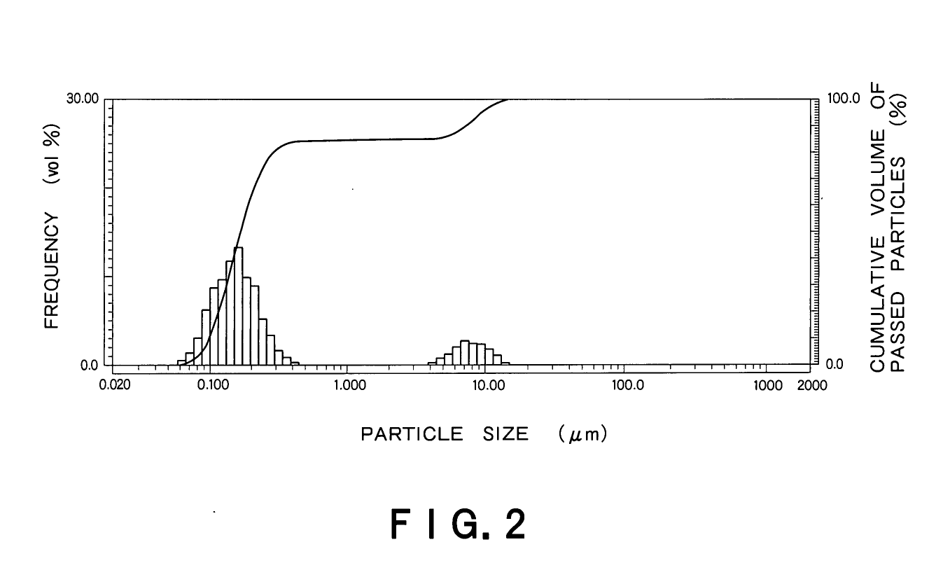

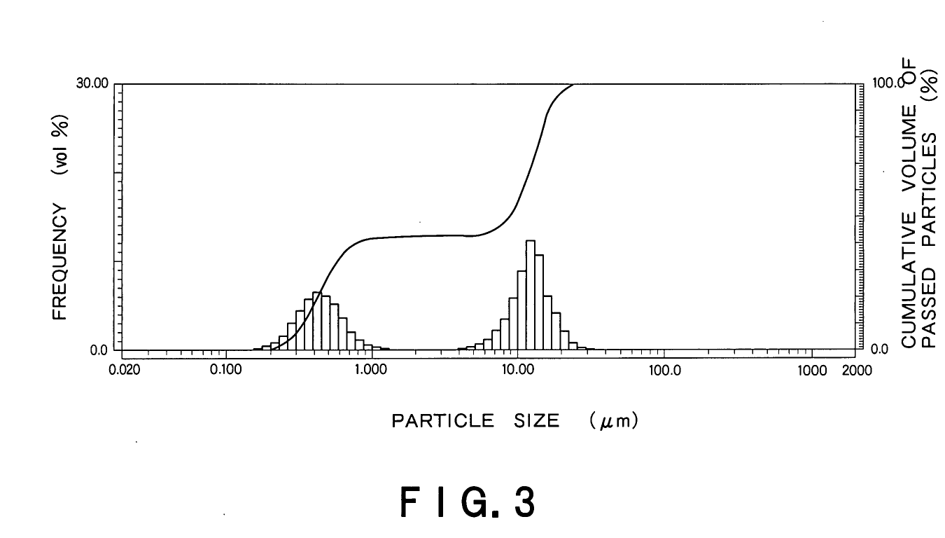

On Samples 1 and 2, the laser diffraction/scattering-type particle-diameter distribution measuring instrument (LA-920 produced by HORIBA Seisakusho) was used to measure the particle size distribution on a volume basis as in the case described above. The particle size distribution of Sample 1 on a volume basis is shown in FIG. 2, and the particle size distribution of Sample 2 on a volume basis is shown in FIG. 3.

Further, on Samples 1 to 4, the laser diffraction/scattering-type particle-diameter distribution measuring instrument (LA-920 produced by HORIBA Seisakusho) was used to measure the 10% average particle diameter on a number basis (D10) and the 90% average particle diameter on a volume basis (D90) as in the case described above. The results are shown the following table 1.

### Example 2

### Producing of Coating a Film Using Aerosol

Samples 1 to 4 of the aluminum oxide fine particles obtained in Example 1 were used to produce a film as described below. The sample obtained in Example 1 was fed into the aerosol generator 103 of the forming apparatus 10 shown in FIG. 1. Then, while a helium gas as a carrier gas was flowing through the apparatus at a flow rate of 7 L/min., aerosol was generated, which was then ejected onto a stainless (SUS) substrate. Thus, an aluminum oxide film of the forming area 10 mm×17 mm was formed on the substrate.

The thickness of the formed aluminum oxide film was measured by the use of a stylus-type surface profile measuring instrument (produced by Nippon Shinkuu Gijutu Corporation, Decktak3030), thereby calculating a forming rate of the aluminum oxide film (μm·cm/min.). The film formation rate (μm·cm/min.) means the thickness (μm) of the film formed for every 1 cm of a scanning distance for one minute. The Vickers hardness of the formed aluminum oxide film was measured by the use of a dynamic ultra-micro hardness tester (DHU-W201, Shimadzu Seisakusho). The measurement results are shown in Table 1.

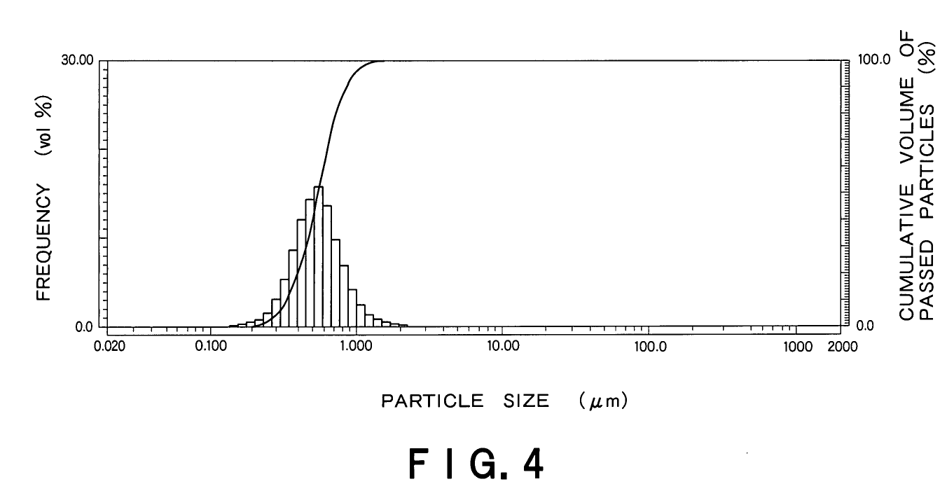

Further, for comparison, commercially available aluminum oxide fine particles were provided as Comparative Sample 1 for the raw fine particles. The 50% average particle diameter of the raw fine particles on a volume basis is 0.53 μm. As in the case of Example 1, a particle size distribution on a volume basis, the 10% average particle diameter on a number basis (D10), and the 90% average particle diameter on a volume basis (D90), regarding Comparative Sample 1, were measured. The particle size distribution of Comparative Sample 1 on a volume basis is shown in FIG. 4. Next, Comparative Sample 1 was used to form and measure an aluminum oxide film as in the case described above. The results are shown in the following table 1.

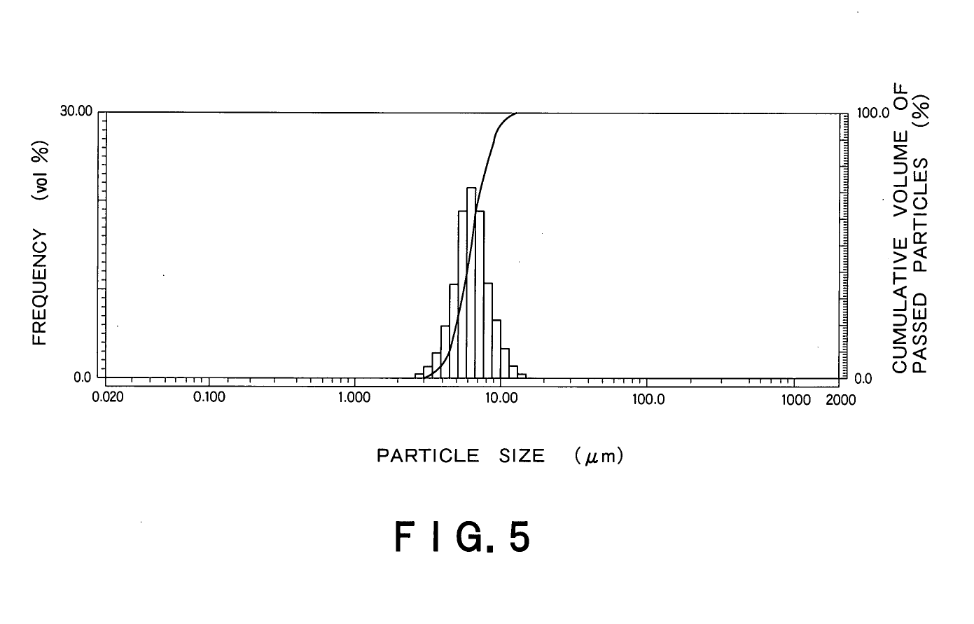

Further, for comparison, the auxiliary particles 2 used in the Example 1 were provided as Comparative Sample 2 for the auxiliary particles. As in the case of Example 1, the particle size distribution on a volume basis, the 10% average particle diameter on a number basis (D10), and the 90% average particle diameter on a volume basis (D90), regarding Comparative Sample 2, were measured. The particle size distribution of Comparative Sample 2 on a volume basis is shown in FIG. 5. Next, Comparative Sample 2 was used to form an aluminum oxide film as in the case described above. As shown in the following table 1, however, the result is that an aluminum oxide film was not formed.

TABLE 1

| | 10% average diameter | 90% average diameter | Film formation rate | Vickers |
|---|---|---|---|---|
| | on a number basis (μm) | on a volume basis (μm) | (μm · cm/min.) | hardness (HV) |
| Sample 1 | 0.07 | 7.07 | 3.1 | 799 |
| Sample 2 | 0.19 | 16.35 | 1.9 | 1387 |
| Sample 3 | 0.15 | 8.04 | 1.2 | 1430 |
| Sample 4 | 0.19 | 16.35 | 1.9 | No |
| | | | | measurement |
| Comparison | 0.21 | 0.88 | 0.2 | 1400 |
| Sample 1 | | | | |
| Comparison | 3.25 | 9.05 | No film formation | No film |
| Sample 2 | | | | formation |

As shown in Table 1, when Samples 1 to 4 comprising the raw fine particles and the auxiliary particles are used, it is seen that a film with a high Vickers hardness is able to be formed at a high film formation rate. On the other hand, in Comparative Sample 1 composed of the raw fine particles alone, the film formation rate was significantly reduced. Further, in Comparative Sample 2 composed of the auxiliary particles alone, even a film cannot be formed.

### Example 3

### Example of Using Auxiliary Particles of a Different Material from that of the Raw Fine Particles (1)

As raw fine particles, commercially available yttrium oxide (Y₂O₃) fine particles were provided. The 50% average particle diameter of the raw fine particles on a volume basis was 0.47 μm. Next, the raw fine particles and the auxiliary particles used in Example 1 were mixed together at a number ratio of (auxiliary particles 1):(raw fine particles)=1:100, to obtain a particle mixture. The obtained particle mixture was used to form and measure an yttrium oxide film as in the case of Example 2. As a result, a satisfactory film was formed on the substrate.

Further, for comparison, the yttrium oxide fine particles alone were used to experiment on forming an yttrium oxide film as in the case described above. However, an yttrium oxide film was not formed.

### Example 4

### Example of Using Auxiliary Particles of a Different Material from that of the Raw Fine Particles (2)

As raw fine particles, commercially available forsterite (2MgO.SiO) fine particles were provided. The 50% average particle diameter of the raw fine particles on a volume basis was 0.32 μm. Next, as auxiliary particles, aluminum oxide fine particles having a 50% average particle diameter of 3.2 μm on a volume basis were provided. Then, the raw fine particles and the auxiliary particles were mixed together at a number ratio of (auxiliary particles):(raw fine particles)=1:30, to obtain a particle mixture. The obtained particle mixture was used to form and measure a forsterite film as in the case of Example 2. As a result, dense films with a volume resistivity of 10¹⁵(Ω·cm) were produced at a high film formation rate of 2.0 to 3.0 μm·cm/min.

Further, for comparison, the forsterite fine particles alone were used to experiment on forming a forsterite film as in the case described above. However, a film formed had a volume resistivity of 10¹⁰(Ω·cm) and was close to green compact, and a dense film was not able to be formed.

### Example 5

### Example of Using Auxiliary Particles of a Different Material from that of the Raw Fine Particles (3)

As raw fine particles, commercially available barium titanate (BaTiO3) fine particles were provided. The 50% average particle diameter of the raw fine particles on a volume basis was 0.13 μm. Next, as auxiliary particles, aluminum oxide fine particles having a 50% average particle diameter of 55 μm on a volume basis were provided. Then, the raw fine particles and the auxiliary particles were mixed together at a number ratio of (auxiliary particles):(raw fine particles)=1:4.0×10⁶, to obtain a particle mixture. The obtained particle mixture was used to form and measure a barium titanate film as in the case of Example 2. As a result, a film formation rate was 22.0 μm·cm/min., and the Vickers hardness of the barium titanate film was HV520 approximately equal to that of sintered body.

For comparison, the barium titanate fine particles alone were used to experiment on forming a barium titanate film as in the case described above. However, the Vickers hardness of the obtained film was HV300, which was lower than the Vickers hardness of HV520 in the case of using the auxiliary particles (aluminum oxide fine particles).

1. A method for producing a film by use of aerosol, the method comprising:
mixing a particle mixture with a carrier gas to form an aerosol;
ejecting the aerosol onto a surface of a substrate to make the particle mixture come into collision with the substrate, the collision crushing or deforming the particles to form a film on the substrate,
wherein the particle mixture comprises raw fine particles comprising a brittle material as a main component and having a 50% average particle diameter (D50) of 0.010 μm to 1.0 μm on a volume basis, and auxiliary particles comprising a brittle material of the same type as or a different type from the brittle material of the raw fine particles as a main component and having a 50% average particle diameter (D50) of 3.0 μm to 100 μm on a volume basis.

2. A method according to claim 1, wherein the auxiliary particles have a 50% average particle diameter (D50) of 5.0 μm to 50 μm on a volume basis.

3. A method according to claim 1, wherein the auxiliary particles have a 50% average particle diameter (D50) of 7.0 μm to 20 μm on a volume basis.

4. A method according to claim 1, wherein the raw fine particles have a 50% average particle diameter (D50) of 0.030 μm to 0.80 μm on a volume basis.

5. A method according to claim 1, wherein the particle mixture have a 10% average particle diameter (D10) of 0.03 μm to 0.50 μm on a number basis and a 90% average particle diameter (D90) of 3.00 μm to 25 μm on a volume basis.

6. A method according to claim 1, wherein a ratio of the number of raw fine particles to the number of auxiliary particles in the particle mixture is 1.0×10² to 1.0×10⁷.

7. A method according to claim 1, wherein the brittle material is a nonmetallic inorganic material.

8. A method according to claim 7, wherein the nonmetallic inorganic material is at least one selected from the group consisting of an inorganic oxide, inorganic carbide, inorganic nitride, inorganic boride, a multi-component solid solution, ceramics and a semiconductor material.

9. A method according to claim 1, wherein the raw fine particles is a mixture of raw fine particles of the two or more types of the brittle materials.

10. A method according to claim 1, wherein the substrate comprises at least one selected from the group consisting of glass, metal, ceramics, a semiconductor, and an organic compound.

11. A method according to claim 1, wherein the carrier gas comprises at least one selected from the group consisting of nitrogen, helium, argon, oxygen, hydrogen, and dry air.

12. A method according to claim 1, wherein a forming rate of the film is 1.0 μm·cm/minute or more.

13. A particle mixture used as a material for the film in the method according to claim 1, comprising:
raw fine particles comprising a brittle material as a main component and having a 50% average particle diameter (D50) of 0.010 μm to 1.0 μm on a volume basis; and
auxiliary particles comprising a brittle material of the same type as or a different type from the brittle material of the raw fine particles as a main component and having a 50% average particle diameter (D50) of 3.0 μm to 100 μm on a volume basis.

14. A particle mixture according to claim 13, wherein the auxiliary particles have a 50% average particle diameter (D50) of 5.0 μm to 50 μm on a volume basis.

15. A particle mixture according to claim 13, wherein the auxiliary particles have a 50% average particle diameter (D50) of 7.0 μm to 20 μm on a volume basis.

16. A particle mixture according to claim 13, wherein the raw fine particles have a 50% average particle diameter (D50) of 0.030 μm to 0.80 μm on a volume basis.

17. A particle mixture according to claim 13, having a 10% average particle diameter (D10) of 0.03 μm to 0.50 μm on a number basis and a 90% average particle diameter (D90) of 3.00 μm to 25 μm on a volume basis.

18. A particle mixture according to claim 13, wherein a ratio of the number of raw fine particles to the number of auxiliary particles is 1.0×10² to 1.0×10⁷.

19. A particle mixture according to claim 13, wherein the brittle material is a nonmetallic inorganic material.

20. A particle mixture according to claim 19, wherein the nonmetallic inorganic material is at least one selected from the group consisting of an inorganic oxide, inorganic carbide, inorganic nitride, inorganic boride, a multi-component solid solution, ceramics and a semiconductor material.

21. A particle mixture according to claim 13, wherein the raw fine particles are a mixture of raw fine particles of the two or more types of the brittle materials.

22. A film produced by the method according to claim 1.

23. A film according to claim 22, wherein the film substantially comprises poly crystals.

24. A film according to claim 22, having substantially no grain boundary layer formed of a vitreous material.

25. A film according to any one of claims 22, having a Vickers hardness of HV1000 or more.

26. A composite material comprising:
a substrate; and
a film according to claim 22 formed on the substrate.

27. A composite material according to claim 26, wherein the substrate comprises at least one selected from the group consisting of glass, metal, ceramics, a semiconductor, and an organic compound.

28. A composite material according to claim 26, wherein the fine particles bite into the substrate surface to form an anchor portion.
